(19) United States
(12) Patent Application Publication
(10) Pub. No.: US 2010/0237094 A1
(43) Pub. Date: Sep. 23, 2010

(54) PLUNGER APPARATUS FOR EMPTYING A CARTRIDGE USING PAINT STIR STICK

(76) Inventor: Wilken Benjamin, II, Mundelein, IL (US)

Correspondence Address: MUETING, RAASCH & GEBHARDT, P.A., P.O. BOX 581336, MINNEAPOLIS, MN, 55458-1336, US

(21) Appl. No.: 12/406,685

(22) Filed: Mar. 18, 2009

(51) Int. Cl. G01F 11/00; B65D 83/76

(52) U.S. Cl. 222/1; 222/319; 222/386; 222/326

(57) ABSTRACT

A cartridge including a plunger apparatus and methods for emptying the contents within a cartridge using the plunger apparatus (e.g., using a paint stir stick to empty the contents).

### BACKGROUND

The disclosure herein relates generally to a plunger apparatus and methods for emptying the contents within a cartridge using the plunger apparatus.

Various containers are available that hold viscous materials, e.g., viscous liquids. For example, various paint products such as colorant are provided in containers that are emptied upon use, e.g., poured from the container. In many circumstances, the contents of containers are relatively expensive. As such, it is economically beneficial to substantially remove all of the viscous materials that are resistant to flow from the container (e.g., adhere to the sides of the container or are left at the bottom of a container).

Many products are dispensed from containers, such as cartridges, with use of a plunger. For example, materials may be removed or dispensed from the cartridge using a caulk gun or a similar type apparatus (e.g., a plunger is moved along the axis of the cartridge to assist in removal of the contents of the cartridge).

### SUMMARY

The disclosure herein relates generally to methods and apparatus for removing contents from a cartridge using a plunger apparatus (e.g., a plunger apparatus upon which a manual force may be applied using an object, such as a paint stir stick, to move the plunger apparatus along an axis of the cartridge to remove contents from the cartridge).

### BRIEF DESCRIPTION OF THE DRAWINGS

FIG. 1 is a bottom perspective view of an exemplary embodiment of a cartridge including a plunger apparatus.

FIG. 2 is a side view of the exemplary cartridge of FIG. 1.

FIG. 3 is a bottom view of the exemplary cartridge of FIG. 1.

FIGS. 4A-4C are a top view, a side view partially cut-away, and a detailed view of a portion of the cut-away part of one exemplary embodiment of a cartridge body that may be used with the cartridge shown in FIG. 1, respectively.

FIG. 5 is a bottom perspective of one exemplary embodiment of a plunger apparatus that may be used as part of the cartridge shown in FIG. 1.

FIG. 6 is a bottom view of the exemplary plunger apparatus of FIG. 5.

FIG. 7 is a side view of the exemplary plunger apparatus of FIG. 5.

FIG. 8A is a cross-section view of the exemplary plunger apparatus of FIG. 5 taken at line 8-8 of FIG. 6.

FIG. 8B is a more detailed cross-section view of a portion of the exemplary plunger apparatus of FIG. 8A.

FIG. 9 is a bottom perspective of another exemplary embodiment of a plunger apparatus that may be used as part of the cartridge of FIG. 1.

The figures are rendered primarily for clarity and, as a result, are not necessarily drawn to scale.

### DETAILED DESCRIPTION OF EXEMPLARY EMBODIMENTS

In the following detailed description of illustrative embodiments, reference is made to the accompanying figures of the drawing which form a part hereof, and in which are shown, by way of illustration, specific embodiments which may be practiced. It is to be understood that other embodiments may be utilized and structural changes may be made without departing from the scope of the disclosure.

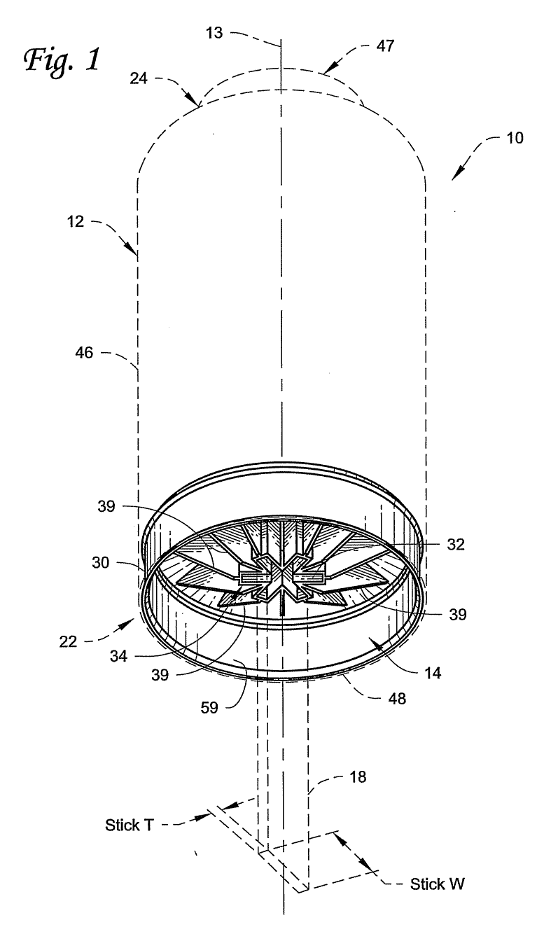

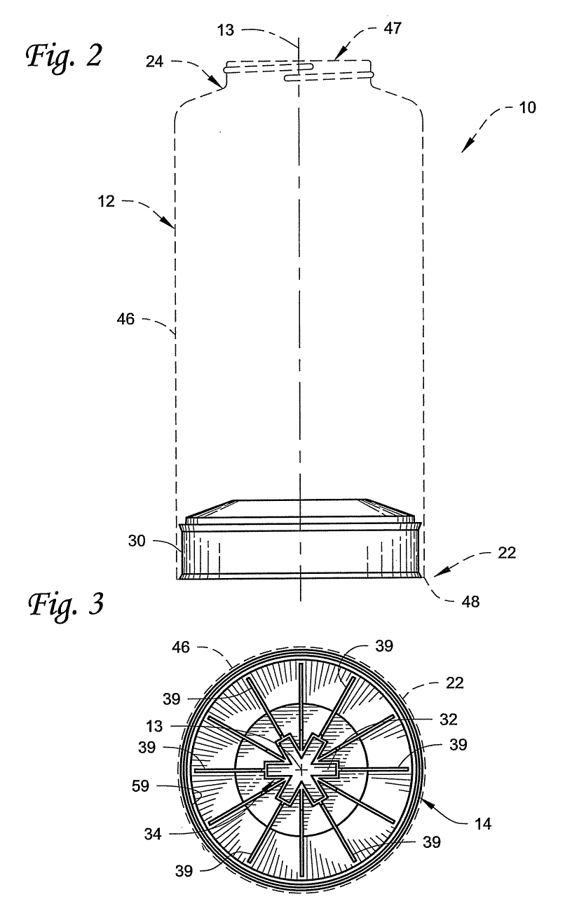

An exemplary embodiment of a cartridge 10 is shown in FIGS. 1-3. The cartridge 10 includes an elongated cartridge body 12 extending along axis 13 between a dispensing end 24 from which contents contained within a volume defined by the cartridge 10 can be dispensed and a plunger end 22.

The cartridge 10 further includes a plunger apparatus 14 positioned along the axis 13 of the cartridge body 12 to seal the plunger end 22. The plunger apparatus 14 includes one or more surfaces 30 positioned for contact with the cartridge body 12 to remove contents contained within the cartridge body 12 as the plunger apparatus 14 is moved towards the dispensing end 24. Further, the plunger apparatus 14 includes object receiving structure 34 (e.g., paint stir stick receiving structure). The paint stir stick receiving structure 34 defines one or more radial slots 32 centered on the axis 13 of the cartridge body 12. Each of the one or more radial slots 32 is configured to receive, for example, a paint stir stick 18 at the plunger end 22 of the cartridge 10.

At least in one embodiment, an object (e.g., a paint stir stick 18) is inserted within one of the radial slots 32. A force is applied to the plunger apparatus 14 (e.g., a manual force applied by a user or the holder of the paint stir stick) to move the plunger apparatus 14 along the axis 13 of the cartridge body 12 towards the dispensing end 24 to remove substantially all of the contents contained within the volume 11 defined by the cartridge. For example, after inserting the paint stir stick 18 into a radial slot 32, the user may apply a force aligned with axis 13 (e.g., push the paint stir stick 18 in the direction of the dispensing end 24) to initiate movement of the plunger apparatus 14 along axis 13 and move the plunger apparatus 14 along the axis 13 toward dispensing end 24.

In one or more embodiments, the user may also turn or twist the paint stir stick 18. For example, in one embodiment, a turning motion on the paint stir stick 18 may be used to initiate movement of the plunger apparatus 14 from its starting position (e.g., a starting position that provides a sealed plunger end 22), while thereafter, only a pushing force may be used to move the plunger apparatus 14 toward the dispensing end 24.

The components described herein (e.g., the cartridge body, plunger apparatus, etc.) may be formed of any suitable material, e.g., metal, polymer, paper product, and/or any other material as would be known by one skill in the art. Further, different components may be formed of different materials (e.g., the cartridge body may be formed of paper or metal, while the plunger apparatus may be formed of plastic). In one or more embodiments, the materials used may depend on the contents retained in the cartridge (e.g., chemical compatibility of materials used for the cartridge and the contents contained therein).

Further, the contents contained within the cartridge may be any composition that can be expelled using the plunger apparatus as described herein (e.g., viscous mixing materials, sealing materials, adhesive compositions, etc.). For example, the contents may be viscous materials that are resistant to flow, such as various paint related products (e.g., paint colorant, paint, stain, etc.). For example, the plunger apparatus described herein may be beneficial for use with compositions relating to a painting process (e.g., where a paint stir stick is generally readily at hand). For example, compositions such as paint colorant at mixing stations may be contained within the cartridges, as well as compositions such as sealants or caulk (e.g., generally a paint stir stick is available when dealing with a caulking process that may precede a painting operation).

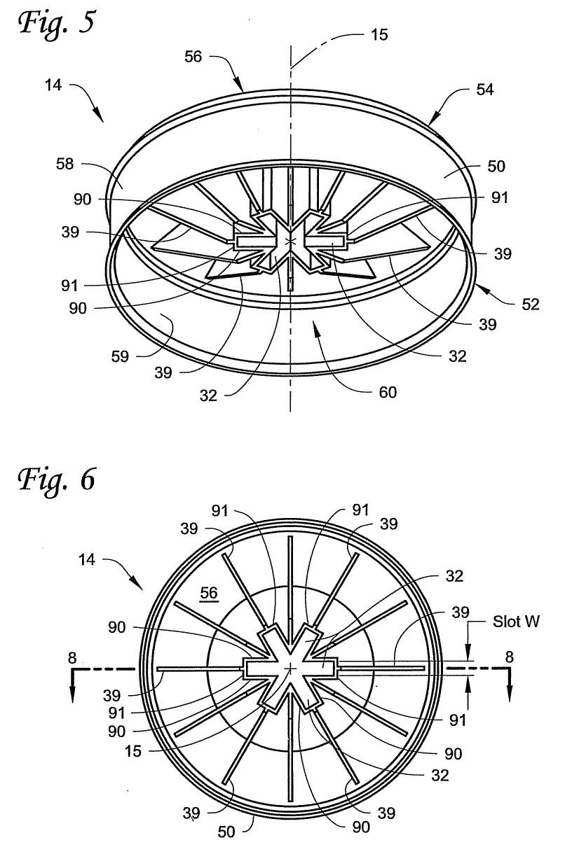

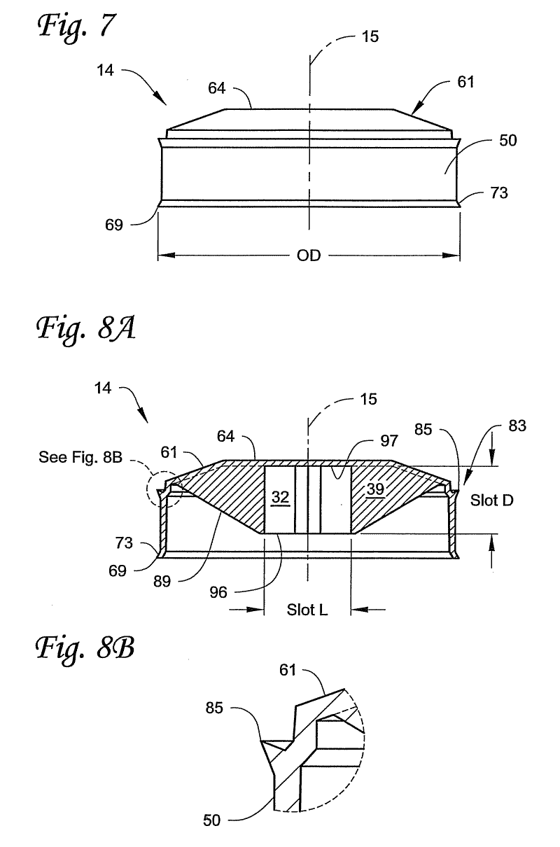

As shown in FIGS. 1-3, the object receiving structure 34 may define one or more radial slots 32 centered on the axis 13 of the cartridge body 12. As shown more clearly in FIGS. 5-8, each of the radial slots 32 may have a length (Slot L) orthogonal to and centered on the axis 13 of the cartridge body 12 that is longer than a width (Slot W) of the radial slot 32. The width (Slot W) is orthogonal to the length (Slot L) of the radial slot 32. Further, each of the radial slots 32 has a depth (Slot D) extending along the axis 13 of the cartridge body 12.

At least in one embodiment, the length (Slot L) orthogonal to and centered on the axis 13 of the cartridge body 12 corresponds to the width (Stick W) of a paint stir stick 18 as shown in FIG. 1. Further, the width (Slot W) orthogonal to the length (Slot L) of the radial slot 32 and centered on the axis 13 of the cartridge body 12 corresponds to the thickness (Stick T) of a paint stir stick 18. The depth (Slot D) of the slot extending along the axis 13 of the cartridge body 12 is deep enough to effectively engage the paint stir stick (i.e., maintain the stir stick 18 in the radial slot 18 without it slipping out during the application of force by the user).

For example, at least in one embodiment, Slot L is greater than or equal to 3 times Slot W. In other embodiments, Slot L is greater than or equal to 4 times the Slot W.

Further, for example, at least in one embodiment, where the dimensions of the radial slots 32 correspond to the dimensions of a paint stir stick 18, the dimensions correspond (e.g., sized to accept receipt of the paint stir stick) to a conventionally sized paint stir stick of the dimensions: Stick W approximately in the range of about ¾ inch to about 1¼ inches and Stick T approximately in the range of about 1/10 inch to about ⅜ inch. For example, the dimensions of each radial slot may be: Slot L may be greater than or equal to about ¾ inch; Slot L may be less than or equal to about 1¼ inches; Slot W may be greater than or about equal to about 1/10 inch; Slot W may be less than or equal to about ⅜ inch; Slot D may be greater than or equal to ½ inch; and Slot D may be less than or equal to about 1½ inches. As used herein, a paint stir stick may refer to a stick made for use with paint or a stick having dimensions substantially similar to a stick made for use in stirring paint (e.g., an elongated stick having a Stick W that is at least 3 times Stick T, or an elongated stick having a Stick W that is at least 4 times the Stick T).

Further, for example as shown in FIGS. 1-3, the plunger apparatus 14 further may include rib elements 39 associated with one or more of the radial slots 32 (e.g. a pair of radially symmetric rib elements 39 aligned with each of the plurality of radial slots 32). For example, at least in the embodiment shown in FIGS. 1-3, the rib elements extend radially from the object receiving structure 34 defining the radial slots 32 toward the one or more surfaces 30 positioned for contact with the cartridge body 12 (e.g., they extend at least partially along a bottom of the plunger apparatus 14 but are not attached to such surfaces 30).

One will recognize as further described herein that the number of radial slots may vary. For example, one radial slot may be used in one or more embodiments. Further, for example, two or more radial slots may be used in other embodiments. Further, the number of ribs 39 used may also vary and the configuration of such ribs may vary as well (e.g., such ribs need not be aligned with the length of the radial slots, more than two ribs may be used when only one radial slot is present, etc.).

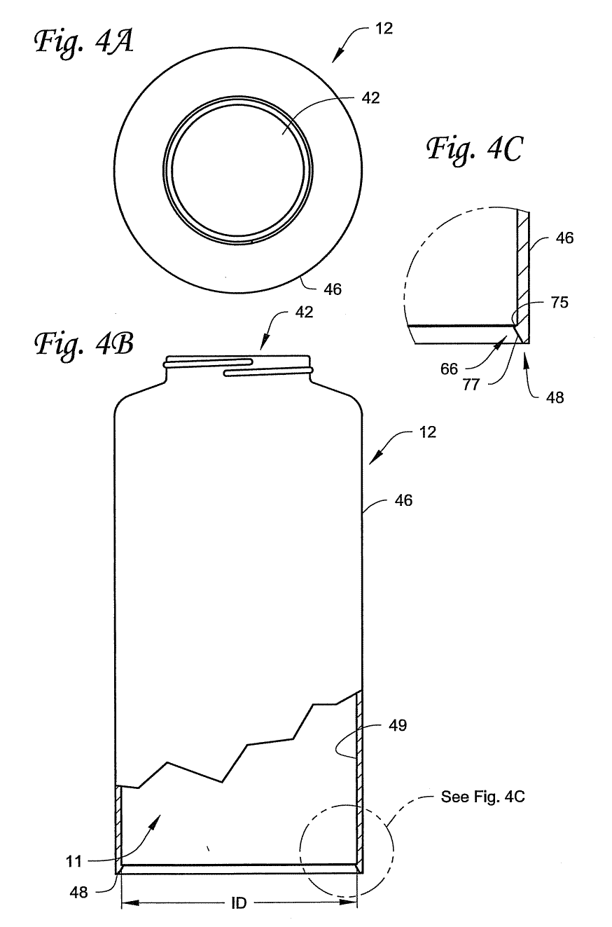

The elongated cartridge body 12 may be of any configuration suitable to define a volume 11 (e.g., see FIG. 4B) for holding contents therein. For example, as shown in FIGS. 4A-4C, the elongated cartridge body 12 may include at least a cylindrical body portion 46 extending along the axis 13 and terminating at an open end 48 at the plunger end 22. Further, the other end of the cylindrical body portion 46 may terminate with a dispensing portion 47 at the dispensing end 24. However, one will recognize that the elongated cartridge body 12 need not have a circular cross-section orthogonal to axis 13, but may, for example, include any other polygonal cross section such as a square, rectangular, or elliptical cross-section. In other words, for example, the elongated cartridge body 12 may be an elongated rectangular cartridge body where the cross-section is a square. There may be advantages to using certain types of cartridge bodies (e.g., a cylindrical cartridge body 12) over one or more other configurations (e.g., ease of pushing a plunger apparatus through a body that does not have corners).

The dispensing portion 47 of the cartridge 10 may be of any configuration suitable for dispensing contents from the cartridge body 12. For example, as shown in FIGS. 4A-4C, the dispensing portion 47 may include a threaded opening 42 upon which a threaded cover (not shown) may be coupled. For example, upon removing such a cover, the contents of the cartridge 10 may be poured from the cartridge 10. Further, after the contents are poured from the cartridge 10, the remaining contents may be forced out by moving the plunger apparatus 14 along axis 13. For example, at least in one embodiment, the contents may be a viscous liquid (e.g., paint colorant) that may be poured from the cartridge 10 with the remaining liquid being forced out using the plunger apparatus 14. As such, substantially all of the contents (e.g., colorant) may be removed from the cartridge 10.

One will recognize that the dispensing portion 47 is not limited to any particular configuration. For example, the dispensing portion 47 may include any opening shape or size and/or any type of cover (e.g., integral or separate) positioned thereon (e.g., a snap on cover, protective cover, closure insertable in the opening, etc.). Further, for example, the dispensing portion 47 may be configured such that a portion may be removed to create an opening for dispensing contents (e.g., a caulk tube including a nozzle that is cut to create an opening).

One embodiment of the open end 48 of the elongated cartridge body 12 is shown in detail in FIG. 4C. For example, the open end 48 may be defined by a retaining projection 66 extending inward toward axis 13 at the open end 48. The retaining projection 66 may include one or more tapered surfaces (75, 77) for mating with the circumferential lip 69 of the plunger apparatus 14 when assembled (e.g., a tapered surface of the lip 69 may be in contact with and temporarily retained by the tapered surface 77 to provide a sealed volume 11; a force by the user on a paint stir stick may then be used to overcome such retention). However, any configuration suitable for providing a seal at the open end 48 to define a volume 11 for holding contents in the cartridge 12 may be used. One will recognize that, in one or more embodiments, the plunger apparatus 14 may be positioned anywhere along the axis 13 to seal the open end 48 and that the plunger apparatus 14 need not be positioned at the structural end of the cartridge body 12. For example, part of the cartridge body may extend past the location of the plunger apparatus 14.

The plunger apparatus 14 may be of any configuration suitable for use in expelling contents from the cartridge body 12 as the plunger apparatus 14 is moved along axis 13 thereof toward the dispensing end 24. For example, as shown in the FIGS. 5-8, the plunger apparatus 14 may include a cylindrical body portion 50 positioned for contact with an inner surface 49 of the cartridge body 12 to remove contents contained within the cartridge body 12 as the plunger apparatus 14 is moved towards the dispensing end 24. However, one will recognize that the plunger apparatus 14 need not include a cylindrical body portion 50 for contact with the inner surface 49, but may, for example, include any other shaped body portion for mating with the particular cross-section of the cartridge body (e.g., mating with a square, rectangular, or elliptical cross-section). In other words, for example, the plunger apparatus may include a square body portion for mating with a cartridge body that has a square cross-section. There may be advantages to using certain types of plunger apparatus (e.g., those having cylindrical surfaces) over one or more other configurations (e.g., ease of pushing a plunger apparatus through a body that does not have corners).

As shown in the FIGS. 5-8, at least in one embodiment, the plunger apparatus 14 includes the cylindrical body portion 50 positioned for contact with the inner surface 49 of the cylindrical body portion 46 of the cartridge body 12. In other words, the one or more cylindrical surfaces 50 are sized relative to the inner surface 49 of the cylindrical body portion 46 to remove contents contained within the cartridge body 12 (e.g., either directly or indirectly) as the plunger apparatus 14 is moved towards the dispensing end 24. In one or more various embodiments, the contact with the inner surface 49 of the cylindrical body portion 46 to remove contents therein may be accomplished either directly or indirectly by portions of the plunger apparatus 14 (e.g., one portion of the plunger apparatus may force another surface thereof into contact with the inner surface 49, or another component, either a part of or separate for the plunger apparatus, may be in contact with the inner surface 49 to assist in removing the contents from the cartridge).

The cylindrical body portion 50 extends along an axis 15 (i.e., coincident with axis 13 when positioned at plunger end 22 to seal opening 48) between a first end 52 and a second end 54. A plunger bottom 56 terminates the second end 54 of the cylindrical body portion 50. The first end 52 is open to allow access to the one or more radial slots 32.

The cylindrical body portion 50 includes an outer cylindrical surface 58 at the perimeter thereof and an inner cylindrical surface 59 defining opening 60 of the plunger apparatus 14. At least in one embodiment, the outer cylindrical surface 58 is slightly over-sized relative to the inner surface 49 of the cylindrical cartridge body 12 to form a contact fit therebetween.

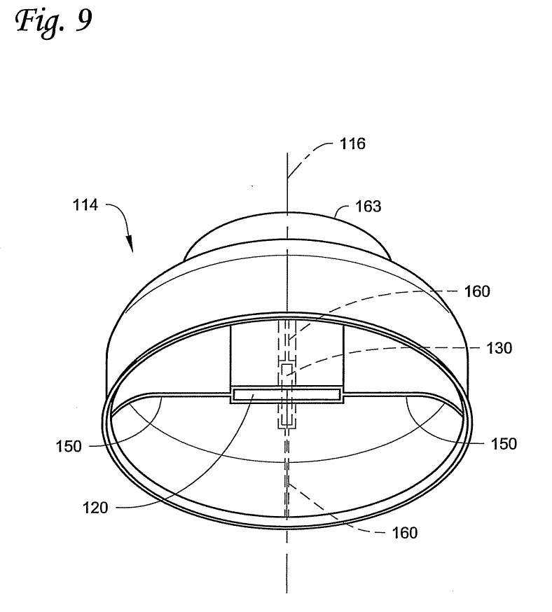

The plunger bottom 56 may be of any suitable configuration for closing the plunger end 22 of the cartridge body 12. For example, in one embodiment shown in FIGS. 1-8, the plunger bottom 56 includes a transition portion 61 (e.g., a tapered portion) extending from the cylindrical body portion 50 and terminating in a flat surface 64. For example, in one embodiment, the flat surface 64 may be circular and have a diameter less than that of the cylindrical body portion 50 of the plunger apparatus but greater than the length (Slot L) of a radial slot 32 (e.g., the width of a paint stir stick). Further, the plunger bottom 56 may have a shape (e.g., a depth associated therewith, such as an extension portion 163 shown in an alternate embodiment of FIG. 9) sufficient to permit the slot 32 to have a depth effective for engaging a paint stir stick therein.

Further, at least in one embodiment, a circumferential lip 69 terminates the second end 52 of the cylindrical portion 50. For example, the circumferential lip 69 may have an outer diameter (OD) greater than the inner diameter (ID) of the inner surface 49 of the cylindrical body portion 46. Further, for example, the circumferential lip 69 may be configured to cooperate with the open end 48 to provide a sealed plunger end 22. As shown in FIGS. 5-8, for example, the circumferential lip 69 may include a tapered surface 73 configured to mate with the open end 48 shown in detail FIG. 4C (e.g., mate with tapered surface 77). However, as described herein, the present disclosure is not limited to any particular method of providing the seal between the plunger apparatus and the cartridge body.

Still further, in addition to the circumferential lip 69 that terminates the second end 52 of the cylindrical portion 50 and provides a sweeping effect on any material present on the inner surface 49 of the cylindrical body portion 46, in one embodiment, the plunger apparatus 14 may also include a scraping structure 83 for scraping material present on the inner surface 49 of the cylindrical body portion 46 as the plunger apparatus 14 is moved along axis 13. For example, the scraping structure 83 may include a circumferential projection lip 85 (e.g., in the region where the transition portion 61 extend inward from the cylindrical body portion 50) that has an outer diameter greater than the inner diameter of the inner surface 49 of the cylindrical body portion 46 to provide a scraping of material present on the inner surface 49 as the plunger apparatus 14 is moved along axis 13. For example, the circumferential lip 69 and the projection lip 85 may be configured to provide a scrape and sweep operation to remove the material from the cylindrical body portion 46 (e.g., the lip 85 having a scraping end pointed towards the direction in which the plunger is being moved while the lip 69 includes a sweeping end pointed towards a direction opposite plunger movement direction). However, as described herein, the present disclosure is not limited to any particular structure of scraping or sweeping the material from the cartridge 10, although some may be more effective than others.

As shown in FIGS. 1-3, the plunger apparatus 14 further includes the object receiving structure 34 (i.e., paint stir stick receiving structure) that defines one or more radial slots 32 (e.g., radial slots elongated in a direction orthogonal to the axis 13) centered on the axis 13 of the cartridge body 12 configured to receive, for example, a paint stir stick 18 at the plunger end 22 of the cartridge 10. One embodiment of the object receiving structure 34, as shown in FIGS. 1-8, defines a plurality of radial slots 32 (e.g., three radial slots) centered on the axis 13 of the cartridge body 12 when assembled with the cartridge body 12. As described herein, each of the radial slots 32 may have a length (Slot L), a width (Slot W), and a depth (Slot D). Further, as described herein, the length (Slot L) may correspond to the width (Stick W) of a paint stir stick, the width (Slot W) may correspond to the thickness (Stick T) of the paint stir stick 18, and the depth (Slot D) of the slot is deep enough to effectively engage the paint stir stick 18 in the radial slot, for example, during the application of force, e.g., axial, on the stick 18 by the user. However, the size of each of the radial slots need not all be the same.

Further, for example, at least in one embodiment, the length (Slot L) of each of the one or more radial slots 32 is defined by opposing side walls 90 extending from the plunger bottom 56 (e.g., from flat surface 64 of the plunger bottom). Further, the width (Slot W) of each of the one or more radial slots 32 is defined by opposing end walls 91 extending from the plunger bottom 56 (e.g., from flat surface 64 of the plunger bottom). The opposing end walls 91 are coupled to ends of the opposing side walls 90 to form a rectangular shaped slot 32; open at a first end 96 to receive an object (e.g., a paint stir stick) and closed at the second end 97 (e.g., by the plunger bottom 56). The closed second end 97 provides a surface upon which the end of a paint stir stick 18 may contact. It will be recognized that the radial slot 32 need not be in direct contact with the plunger bottom 56 (e.g., the slot 32 could be suspended from the surface by the ribs or other structure, or have another structure or surface to form its bottom).

One will recognize that the one or more radial slots 32 may be formed by any structure and not just by a plurality of walls. For example, the radial slots may be formed in a solid plunger apparatus (e.g., openings in a solid cylindrical body portion), may be openings formed in a block of material positioned in the cylindrical body portion 50, or may be formed using any other configuration of material that provides one or more radial slots.

Further, for example as shown in FIGS. 1-8, the plunger apparatus 14 may include rib elements 39 to, for example, provide strength to the structure of the plunger apparatus 14. For example, as shown in more detail in FIGS. 5-8, rib elements 39 are aligned with each of the plurality of radial slots 32 (e.g., a pair of radially symmetric rib elements 39 are aligned with each of the plurality of radial slots 32) and other rib elements 39 extend from the intersection of adjacent radial slots 32 (e.g., some ribs elements extend from the opposing end walls and others extend from regions between the intersection of side walls of adjacent radial slots). For example, at least one embodiment, the rib elements 39 extend radially from the opposing end walls 91 used to define the radial slot 32 and/or from regions at the intersection of side walls 90 of adjacent radial slots 32 towards the inner surface 59 of the cylindrical body portion 50.

However, at least in one embodiment, the rib elements 39 do not attach to the inner surface 59, but rather extend along the plunger bottom 56 and terminate prior to the inner surface 59. For example, as shown in FIG. 8A (as well as certain other figures), the rib elements 39 may include a tapered portion 89 that terminates near the transition portion 61 of the plunger bottom 56. For example, in this embodiment, the entire cylindrical body portion 50 is allowed to flex as it is moved through the cylindrical body portion 46 of the cartridge 10. As shown in FIGS. 5-8, the rib elements 39 are fixed to the plunger bottom 56. However, the rib elements could be at least partially suspended above the plunger bottom 56 (e.g., only attaching in one or more locations).

One will recognize that various configurations of the rib elements 39 may be possible. For example, the number of rib elements 39 used with each radial slot may vary and the configuration of such rib elements may vary as well. For example, the rib elements may not be aligned with the length of the radial slots (e.g., one or more multiple rib elements may extend towards the inner surface 59 of the cylindrical body at an angle relative to the length of the radial slot). Further, for example, the shape and size of the rib elements may vary (e.g., planar ribs, ribs having a greater thickness at one end versus the other, ribs formed of multiple portions, etc.). Yet further, for example, the number of rib elements do not need to correspond to the number of radial slots (e.g., there does not need to be two rib elements for each slot). For example, some slots may be associated with a pair of rib elements and others may not. Further, for example, there may be multiple rib elements supporting a single slot, some of which are aligned with the length of the slot and others which are not aligned (e.g., those extending from an intersection of adjacent radial slots). For example, a single slot embodiment may have a pair of rib elements aligned with the length of the slot and another pair of rib elements extending from the opposing side walls 90 towards the inner surface 59 of the cylindrical body portion 50. One will recognize that various rib element configurations may be used to provide support for one or more radial slots (e.g., provide support as an object is received in the slot and forces are applied to the object so as to move the plunger apparatus 14 along axis 13 of the cartridge body 12). For example, without a supporting rib structure, the object receiving structure 34 defining the one or more radial slots may undesirably twist upon application of an axial or radial force applied to the paint stir stick in the slot.

One will recognize as described herein that the number of radial slots may vary. For example, as shown in FIG. 9, a single elongated radial slot 120 may be used in a plunger apparatus 114. Further, for example, two or more radial slots as represented by radial slot 120 and the dashed line radial slot 130 may be used in other plunger apparatus embodiments. Each of the two or more radial slots (120, 130) are centered on the axis 116 and, at least in one embodiment, are configured to receive a paint stir stick therein.

Further, the number of ribs 150 used may also vary, and the configuration of such ribs may vary as well, depending on the number of radial slots used in the plunger apparatus, as well as other considerations described herein. At least in one embodiment, the plunger apparatus 114 includes a pair of radially symmetric rib elements (150, 160) aligned with each of the two radial slots (120, 130), respectively (e.g., the rib elements (150, 160) of the pair extend radially between the paint stir stick receiving structure defining the corresponding radial slot and the inner surface of the cylindrical body portion of the plunger apparatus 114 (e.g., terminating before or at the inner surface). As the structure defining each of the radial slots is substantially similar to that described with reference to FIGS. 5-8, for simplicity, no further description for FIG. 9 is provided herein.

Illustrative embodiments of this invention are discussed and reference has been made to possible variations within the scope of this invention. These and other variations, combinations, and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

1. A method for emptying the contents of a cartridge, the method comprising: providing a cartridge, wherein the cartridge comprises:
an elongated cartridge body extending along an axis between a dispensing end from which contents contained within a volume defined by the cartridge can be dispensed and a plunger end; and
a plunger apparatus positioned along the axis of the cartridge body to seal the plunger end, wherein the plunger apparatus assists in removing contents contained within the cartridge as the plunger apparatus is moved towards the dispensing end, and further wherein the plunger apparatus comprises paint stir stick receiving structure, wherein the paint stir stick receiving structure defines one or more radial slots centered on the axis of the cartridge body configured to receive a paint stir stick at the plunger end of the cartridge body; and
inserting a paint stir stick within one of the one or more radial slots and applying a force to the plunger apparatus to move the plunger apparatus along the axis of the cartridge body towards the dispensing end to remove the contents contained within the cartridge.

2. The method of claim 1, wherein the plunger apparatus further comprises at least one pair of rib elements aligned with a corresponding radial slot of the one or more radial slots, wherein each rib element of the at least one pair extends radially from the paint stir stick receiving structure defining the corresponding radial slot towards one or more surfaces of the plunger apparatus positioned for contact with the cartridge body to remove contents contained within the cartridge as the plunger apparatus is moved towards the dispensing end.

3. The method of claim 1, wherein the paint stir stick receiving structure defines two or more radial slots, wherein each of the two or more radial slots are centered on the axis of the cartridge body, and further wherein each of the two or more radial slots is configured to receive a paint stir stick at the plunger end of the cartridge.

4. The method of claim 3, wherein the plunger apparatus further comprises a pair of rib elements aligned with each of the two or more radial slots, wherein each rib element of the pair extends radially from the paint stir stick receiving structure defining the corresponding radial slot towards one or more surfaces of the plunger apparatus positioned for contact with the cartridge body to remove contents contained within the cartridge as the plunger apparatus is moved towards the dispensing end.

5. The method of claim 1, wherein each of the one or more radial slots has a depth extending along the axis of the cartridge body, a length orthogonal to and centered on the axis of the cartridge body corresponding to the width of a paint stir stick, and a width orthogonal to the length of the radial slot and centered on the axis of the cartridge body, wherein the width of the radial slot corresponds to the thickness of a paint stir stick.

6. The method of claim 1, wherein the elongated cartridge body comprises at least a cylindrical body portion extending along the axis terminating at an open plunger end, and further wherein the plunger apparatus is positioned along the axis within at least a portion of the cylindrical body portion to seal the plunger end, wherein the plunger apparatus comprises:
at least one cylindrical surface positioned for contact with an inner surface of the cylindrical body portion, wherein the at least one cylindrical surface is sized relative to the inner surface of the cylindrical body portion to remove contents contained within the cartridge as the plunger apparatus is moved towards the dispensing end; and
a plunger bottom closing a first end of the at least one cylindrical surface, wherein the length of each of the one or more radial slots orthogonal to the axis is defined by opposing side walls extending from the plunger bottom, and further wherein the width of each of the one or more radial slots orthogonal to the length is defined by opposing end walls extending from the plunger bottom and coupled to the opposing side walls.

7. The method of claim 6, wherein the plunger apparatus further comprises a circumferential lip terminating a second end of the at least one cylindrical surface opposite the first end, the circumferential lip having an outer diameter greater than the diameter of the inner surface of the cylindrical body portion.

8. The method of claim 6, wherein the plunger apparatus further comprises a pair of rib elements aligned with each of the one or more radial slots, wherein each rib element of the pair extends radially from an opposing end wall of the paint stir stick receiving structure defining the radial slot along at least a portion of the plunger bottom towards the at least one cylindrical surface.

9. The method of claim 1, wherein inserting a paint stir stick within one of the one or more radial slots and applying a force to the plunger apparatus comprises applying at least an axial force on the paint stir stick along the axis of the cartridge body.

10. A cartridge comprising:
an elongated cartridge body extending along an axis between a dispensing end from which contents contained within a volume defined by the cartridge can be dispensed and a plunger end; and
a plunger apparatus positioned along the axis of the cartridge body to seal the plunger end, wherein the plunger apparatus comprises:
one or more surfaces positioned for contact with the cartridge body to remove contents contained within the cartridge as the plunger apparatus is moved towards the dispensing end, and
paint stir stick receiving structure, wherein the paint stir stick receiving structure defines one or more radial slots centered on the axis of the cartridge body configured to receive a paint stir stick at the plunger end of the cartridge body, wherein the length of each of the one or more radial slots orthogonal to the axis is at least 3 times longer than the width of radial slot orthogonal to the length.

11. The cartridge of claim 10, wherein the plunger apparatus further comprises at least one pair of rib elements corresponding to at least one radial slot of the one or more radial slots, wherein each rib element of the pair extends from the paint stir stick receiving structure defining the corresponding elongated slot towards the one or more surfaces positioned for contact with the cartridge body.

12. The cartridge of claim 10, wherein the paint stir stick receiving structure defines two or more radial slots, wherein each of the two or more radial slots are centered on and equally spaced about the axis of the cartridge body, and further wherein each of the two or more elongated slots is configured to receive a paint stir stick at the plunger end of the cartridge.

13. The cartridge of claim 12, wherein the plunger apparatus further comprises a pair of rib elements aligned with each of the two or more radial slots, wherein each rib element of the pair extends from the paint stir stick receiving structure defining the corresponding elongated slot towards the one or more surfaces positioned for contact with the cartridge body.

14. The cartridge of claim 10, wherein each of the one or more radial slots has a depth extending along the axis of the cartridge body, wherein the length of the radial slot orthogonal to and centered on the axis of the cartridge body corresponds to the width of a paint stir stick, and wherein the width of the radial slot corresponds to the thickness of a paint stir stick.

15. The cartridge of claim 10, wherein the elongated cartridge body comprises at least a cylindrical body portion extending along the axis terminating at an open plunger end, and further wherein the plunger apparatus is positioned within at least a portion of the cylindrical body portion to seal the plunger end, and wherein the plunger apparatus comprises:
at least one cylindrical surface positioned for contact with an inner surface of the cylindrical body portion, wherein the at least one cylindrical surface is sized relative to the inner surface of the cylindrical body portion to remove contents contained within the cartridge body as the plunger apparatus is moved towards the dispensing end, and further wherein the paint stir stick receiving structure defines one or more radial slots centered on the axis; and
a plunger bottom closing a first end of the at least one cylindrical surface, wherein the length of each of the one or more radial slots is defined by opposing side walls extending from the plunger bottom, and further wherein the width of each of the one or more radial slots is defined by opposing end walls extending from the plunger bottom and coupled to the opposing side walls thereof.

16. The cartridge of claim 15, wherein the plunger apparatus further comprises a circumferential lip terminating a second end of the at least one cylindrical surface opposite the first end, the circumferential lip having an outer diameter greater than the diameter of the inner surface of the cylindrical body portion.

17. The cartridge of claim 15, wherein the plunger apparatus further comprises a pair of rib elements aligned with each of the radial slots, wherein each rib element of the pair extends radially from an opposing end wall of the paint stir stick receiving structure defining the radial slot along at least a portion of the plunger bottom towards the at least one cylindrical surface.

18. A cartridge comprising:
an elongated cartridge body extending along an axis between a dispensing end from which contents contained within a volume defined by the cartridge can be dispensed and a plunger end; and
a plunger apparatus positioned along the axis of the cartridge body to seal the plunger end, wherein the plunger apparatus comprises:
one or more surfaces positioned for contact with the cartridge body to remove contents contained within the cartridge body as the plunger apparatus is moved towards the dispensing end, and
object receiving structure, wherein the object receiving structure defines a plurality of radial slots centered on and equally spaced about the axis of the cartridge body, each of the radial slots having a length orthogonal to and centered on the axis of the cartridge body that is longer than a width of the radial slot orthogonal to the length thereof.

19. The cartridge of claim 18, wherein the plunger apparatus further comprises a pair of rib elements aligned with each of the plurality of radial slots, wherein each rib element of the pair extend radially from the object receiving structure defining the radial slot towards the one or more surfaces positioned for contact with the cartridge body.

20. The cartridge of claim 18, wherein each of the plurality of radial slots has a depth extending along the axis of the cartridge body, wherein the length of each radial slot orthogonal to and centered on the axis of the cartridge body corresponds to the width of a paint stir stick, and wherein the width orthogonal to the length of the radial slot and centered on the axis of the cartridge body corresponds to the thickness of a paint stir stick.
